(19) United States
(12) Patent Application Publication
(10) Pub. No.: US 2024/0312333 A1
(43) Pub. Date: Sep. 19, 2024

(54) SENSING SYSTEM

(71) Applicant: Rudders Rls Pty Ltd, Donvale (AU)

(72) Inventor: Roger John LA SALLE, Donvale (AU)

(21) Appl. No.: 18/578,119

(22) PCT Filed: Jul. 18, 2022
(86) PCT No.: PCT/IB2022/056577

§ 371 Date: Jan. 10, 2024

(30) Foreign Application Priority Data
Jul. 19, 2021 (AU) 2021902212
Sep. 6, 2021 (AU) 20211902884

(51) Int. Cl. G08B 21/18; G01K 1/024; G01K 3/00; G01K 5/48

(52) U.S. Cl. CPC G08B 21/182; G01K 1/024; G01K 3/005; G01K 5/486

(57) ABSTRACT

The present invention relates generally to a sensing system for monitoring the state of a system of components, and in particular, to a sensing system for monitoring the state of a system of components and for providing a warning when the state of any component within the system of components requires attention.

### CROSS-REFERENCE TO RELATED APPLICATIONS

This PCT patent application claims priority from earlier filed Australian Provisional Patent Application No. 2021902212 for “Sensing System”, filed Jul. 19, 2021, and earlier filed Australian Provisional Patent Application No. 2021902884 for “Sensing System”, filed Sep. 6, 2021, the disclosure of which is incorporated herein by reference.

### FIELD OF INVENTION

The present invention relates generally to a sensing system for monitoring the state of a system of components, and in particular, to a sensing system for monitoring the state of a system of components and for providing a warning when the state of any component within the system of components requires attention.

### BACKGROUND OF THE INVENTION

Electrical systems comprise a variety of electrical components wired or otherwise connected together to perform a variety of functions. One type of electrical system that is commonly employed in commercial or residential applications is an electrical switchboard or an electrical distribution board. Such systems are generally the entry point for receiving electrical power into a premises or facility and are used to distribute power within local areas of that premises or facility, such as, each floor of a city building or various parts of a large factory or facility.

In any electrical system comprising electrical circuits where large electrical currents are flowing, it is possible that excessive heat can be created within the system. Most commonly, excessive heat is generated at connection points where wires or components are fastened to each other, most commonly using screw terminals. In the case where a screw terminal is not fully tightened or becomes loose due to vibration, corrosion or other means, the resistance between the connected components may increase. If a high current is being passed across this resistance a rise in temperature at this connection point can occur. Such a rise in temperature can cause oxidation of the connection and thus further increase the resistance. If this is not addressed, a thermal runaway situation may result, where the temperature may rise to a degree where combustion is possible. In some situations, the time over which this situation can develop to a dangerous level may be a number of years.

Such temperature rises are generally referred to as “hot spots” and are commonly encountered in the design and maintenance of electrical systems. Despite the commonality of the situation, the situation presents a dangerous problem in electrical circuits especially in electrical switchboards and distribution boards that are used in virtually all buildings.

For this reason, a variety of systems have been proposed to detect and identify hot spot situations in electrical systems. The most widespread practice to identify high temperature components and connections is the use of thermal imaging. This generally requires thermal photographs of the electrical circuitry to be taken, whereby high temperatures regions of the circuitry will be visually identified within the photographs. This can then be used to identify the components and connections within the circuitry that are getting excessively hot (hot spots), thereby providing advanced notice of overheating conditions and those components requiring attention.

However, hot spot identification using thermal imagery has been found to be both costly and problematic as thermal pictures are typically taken on a yearly basis and it may take hours for each switchboard to be correctly photographed depending on how large and complex. Further to this and perhaps the most limiting factor associated with using thermal imaging is that the images that are used for analysis are simply taken at a point in time, which may not coincide with a time when high current loads are flowing in the circuits which can cause the hot spots. Thus, a thermal image of a switchboard may fail to identify a potential problem unless it is taken when the hot spot is actually present.

An alternative approach to detect hot spots is to place remote monitored thermocouple detectors on likely high current connections or components with the expectation that these points are the most likely to become dangerous hot spots. Whilst this is a widespread practice, it also has significant shortcomings in that it is relatively expensive and only a few of the many connection points in a switchboard are monitored even though a dangerous hotspot can occur anywhere within the system where high currents are flowing. Another variation of this hot spot detection technique includes the use of fibre optics. In such systems an optical fibre is thermally bonded to extend along likely hot spots or high current connections. The optical fibre is then able to monitor the connections and to send a hot spot alert when transmission conditions within the fibre optic change dues to rising temperatures.

The use of thermocouple detectors and optical fibres for hotspot monitoring has proven problematic as it requires specific placement of numerous wires and cables to the network. This makes the maintenance and the addition of components difficult as switchboards can become enmeshed in wiring and connection points significantly increasing the complexity of the system.

Another method for hot spot detection includes the use of strategically placed powered temperature sensing devices that may include a radio transmitter to allow remote wireless monitoring of the electrical circuit. In such instances, the devices are capable of wirelessly transmitting an alert signal in the event of a detected abnormal temperature rise. However, such remote wireless temperature sensing devices are normally placed strategically at expected hot spots and junctions where high currents are known to be present. Therefore, such devices tend to be large and expensive and are only used to monitor specific high current components and not the system as a whole.

In another hot spot detection approach, chemical formulations have been employed that include chemicals that change colour when exposed to high temperatures. Such chemicals may be in the form of materials that include paints or push on metal or plastic clips or tabs that may be applied to cables or components that represent risks of becoming hotspots. Whilst chemical solutions are low in cost and can be applied in a variety of different forms, they have serious shortcomings in relation to their shelf or operational service life. They are typically limited to three to five years of operation until they require replacement. Additionally, when such a chemical colour change product is exposed at a temperature close to but below the so-called alarm or colour change temperature, the colour change will likely occur as there is a time temperature relationship with chemical colour change reactions. Therefore, the accuracy of such chemical approaches have been found to be very inconsistent and inaccurate. In addition, colour change solutions only show what may have happened in the past in relation to hot spots and do not provide real time alerts of a hot spot event.

Yet another means for hot spot detection is the use of RFID tags that can be placed on potential hot spot connections. RFID tags are designed to respond to interrogations by a charging means generally being a high power electromagnetic signal used to activate the tag for a short time to allow a response signal. RFID tags generally have the shortcoming of large physical size requiring an antenna to receive and reply as well as a limitation of range from the interrogating device especially in the presence of cables and electromechanically components that populate an electrical switchboard. Additionally, RFID signals operate in the wireless frequency spectrum that may require different Spectral Authority approvals for different regions.

Thus, present practices for hot spot monitoring share numerous shortcomings and are typically complex and expensive to implement and in some cases only provide periodic testing results and do not readily monitor every possible cable and connection point in the electrical circuit. In some instances, the systems are inaccurate and can be activated below the target temperature and have limited shelf and service life.

There is a need to provide a sensing apparatus for sensing the presence of hot spots in an electrical system that is both simple to implement and which provides continuous monitoring and can monitor all cables and wires and connection points within the electrical system and does not require Spectral Authority approval for the alarm transmissions from a detected hot spot.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a system for monitoring a state of excessive heat in one or more components of an electrical system, comprising:
at least one detection unit, each detection unit mounted with respect to a component of the electrical system to be monitored so as to be in thermal contact with the component to be monitored; and
a repeater unit remotely located with respect to each detection unit, the repeater unit being configured to receive a signal from at least one of the detection units representative of a state of excessive heat present at the associated component of the electrical system and to emit a warning signal associated therewith;
wherein the at least one detection unit comprises a passive temperature operated contact closure that is triggered when any heat generated at the component to be monitored exceeds a predetermined temperature, wherein the triggered passive temperature operated contact closure causes a power source of the detection unit to supply power to a transmitter mounted within the detection unit to transmit the signal to the repeater unit.

In one embodiment, the passive temperature operated contact closure comprises a micro switch in contact with a glass ampoule such that upon exposure of the glass ampoule to the predetermined temperature the glass ampoule fractures and causes the micro switch to close thereby facilitating the supply of power to the transmitter.

In another embodiment, the passive temperature operated contact closure comprises a thermostat mechanical switch such that upon exposure of the thermostat mechanical switch to the predetermined temperature the thermostat mechanical switch closes thereby facilitating the supply of power to the transmitter.

In one embodiment, the signal transmitted by the detection unit is the form of an electromagnetic radiation signal.

In another embodiment, the signal transmitted by the detection unit is in the form of an electromagnetic optical or infrared non-radio frequency signal. One or more mirrors may be provided to reflect the optical or infrared signal emitted by the detection unit to the repeater unit.

The detection unit may comprise a body configured to be mounted to a surface of the component to be monitored, such that a rise in temperature of the component to be monitored will result in a rise in temperature of the body. The body may be formed from a heat conductive material to conduct heat generated in the component to be monitored to the passive temperature operated contact closure.

The power source may be contained within the detection unit and may be maintained substantially in a dormant state until the passive temperature operated contact closure is triggered, which causes the power source to deliver power to the transmitter to transmit the signal to the repeater unit.

The detection unit may further comprise a controller that is programmed to control the transmitter of the detection unit to control the signal being transmitted to the repeater unit. The controller may be configured to encode the signal transmitted by the transmitter. The encoded signal generated by the controller may comprise an ID code that is received by the repeater unit and which identifies the detection unit transmitting the encoded signal. The repeater unit may, upon receiving the encoded signal, emit a warning signal that identifies the detection unit that generated the signal.

In one embodiment, upon triggering of the passive temperature operated contact closure, the controller may control the transmitter of the detection unit to transmit the signal multiple times over a predetermined period to ensure the signal is received by the repeater unit.

The detection unit may comprise a light source mounted on a surface thereof. Upon triggering of the passive temperature operated contact closure, the controller may control the light source to become illuminated to identify the detection unit. The light source may be a visible LED. In one form, the visible LED may be controlled by the controller to be continuously illuminated following triggering of the passive temperature operated contact closure. In another form, the visible LED may be controlled by the controller to periodically flash following triggering of the passive temperature operated contact closure.

An interrogation device may be further provided for interrogating the status of each detection unit when in the passive state. The interrogation device may comprise a magnet member that is brought into close proximity to the detection member to close a reed switch to enable closure between the controller and the power supply. In such an arrangement, closure of the reed switch by the magnet member of the interrogation device may result in the controller being connected to the power supply to facilitate transmission of a test signal from the transmitter which can be used to test the integrity of the detection unit when in a passive state. The interrogation device may be configured to receive the test signal transmitted by the transmitter and comprises a digital display to convey the results of the test signal. The results of the test signal displayed by the digital display may include a confirmation of receipt of the test signal and the encoded number of the detection unit.

In another embodiment, the controller may be constantly powered by the power supply and configured to transmit a periodic OK signal from the transmitter to the repeater unit. In such an embodiment, upon the repeater unit failing to receive an OK signal within a predetermined time period, the repeater unit may transmit a fault signal to a maintenance provider for attention. The fault signal may identify the specific detection unit requiring maintenance.

In another embodiment of the present invention, multiple repeater units are provided. At least one of the multiple repeater units may be a central repeater unit to which all of the other repeater units are connected. The signals received by each of the other repeater units may be transmitted to the central repeater unit for processing.

In accordance with another aspect of the present invention, there is provided a method of validating communication between each of the detection units and a central repeater unit in the system of claim 1, comprising:
activating each detection unit to transmit a test signal pattern after a predetermined time interval following activation;
recording receipt of the test signal pattern at the central repeater unit;
identifying detection units for which no test pattern signal was received by the central repeater unit; and
flagging each detection unit for which no test pattern signal was received for corrective attention.

The predetermined time interval for transmitting the test signal pattern may be around one hour following activation of the detection unit. The test pattern signal may comprise around five randomly spaced test signals. The five randomly spaced test signals may be around one millisecond in duration.

A controller of the central repeater unit may record receipt of the test pattern signal directly from each detection unit or relayed from a slave repeater unit. The controller may assign a predetermined time period for recording receipt of the test pattern signal from the detection units and any detection unit that has no test pattern signal recorded as being received during this predetermined time period may be identified by the controller as requiring corrective attention. The controller may cause the central repeater unit to transmit a signal identifying each flagged detection unit for corrective attention.

In one embodiment, the test pattern signal transmitted by each detection unit may be an infrared signal.

Following transmission of the test pattern signal, a power source of each detection unit may be disconnected.

### BRIEF DESCRIPTION OF THE DRAWINGS

The invention may be better understood from the following non-limiting description of preferred embodiments, in which:

FIG. 1 is a simplified block diagram of a sensing system in accordance with an embodiment of the present invention;

FIG. 2 is side view of a TAG unit for use in the sensing system of FIG. 1 in accordance with an embodiment of the present invention; and

FIG. 3 is side view of a TAG unit for use in the sensing system of FIG. 1 in accordance with another embodiment of the present invention;

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to its use in detecting an event associated with an electrical system that is representative of a problem or potential issue of concern with one or more components of the electrical system. In a preferred embodiment, the event being detected by the system and method of the present invention is the presence of a hot spot in the associated electrical system that may be typical of a potential fire hazard. However, it will be appreciated that the system and method of the present invention could be employed in detecting a variety of other events within an electrical system that may be associated with temperature changes in a system, as will be appreciated by those skilled in the art.

The system and method of the present invention is based upon a system that employs a passive temperature controlled contact closure to generate an alarm when triggered by a rise in temperature experienced at the passive temperature controlled contact closure. As will be described in more detail below, such a system can be mounted to, or immediately adjacent with, a component to be monitored such that any heat generated at or within the component being monitored will be conducted to the passive temperature controlled contact closure to close a circuit or the like to trigger an alarm.

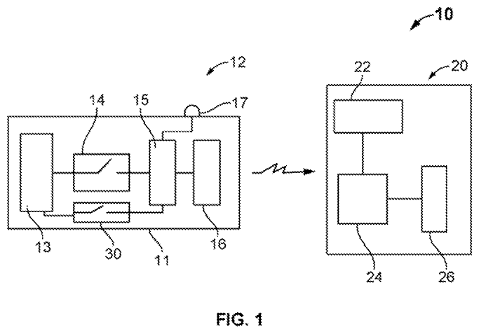

FIG. 1 represents a simplified system diagram of a sensing system 10 in accordance with an embodiment of the present invention. The system 10 comprises two parts, a detection or TAG unit 12 and a repeater unit 20. The TAG unit 12 is configured to sense temperature rises in the components of an electrical system and to generate a signal upon detection of the component rising in temperature above a predetermined temperature. The repeater unit 20 is configured to receive the signal generated by the TAG unit 12 and to process the signal into an alarm signal that can be transmitted to another party or device for action.

The tag unit 12 is configured to be fitted to a component of an electrical circuit to be monitored. In this regard, the component to be monitored may be: a cable; a metallic item, such as a screw connector of a terminal block; or, a body of a specific device, such as a circuit breaker housing or housing for an electric motor or any type of similar apparatus. The body 11 of the TAG unit is sized and shaped to be secured against the component to be monitored and may be made from a material that has high heat conductivity such that any heat generated by the component to be monitored is conducted to the body 11.

The body 11 of the TAG unit 12 contains a power source 13, such as a battery. In its normal state of operation, namely in a state where the component being monitored is operating within acceptable temperature limits, the power source 13 is in a dormant state and not powering any component on the Tag unit 12. A passive temperature operated contact closure 14 provides a connection of the power source 13 to a microprocessor or controller 15. The controller 15 may be in the form of a microcontroller that is in direct contact with a signal transmitter 16, which is controllable to transmit a signal therefrom for detection by the repeater unit 20.

The TAG unit 12 operates when the passive temperature operated contact closure 14 of the body 11 is exposed to a temperature that causes the contact closure 14 to move to a closed position, as will be described in more detail below. When this occurs, the power source 13 becomes activated and is connected to the microprocessor or controller 15 which causes the signal transmitter 16 to transmit a signal indicative of the component being monitored operating at a temperature range above a predetermined range. Such a signal represents an alarm signal which is able to be detected by the repeater unit 20 and acted upon, as will be described in more detail below.

The signal emitted from the signal transmitter 16 of the TAG unit 12 may take a variety of different forms. In one embodiment, the signal may be in the form of an electromagnetic radiation signal. In another embodiment, the signal transmitter 16 be in the form of an optical transmitter, such as an infrared LED or other light transmitter source that transmits the signal in the form of an optical or non-radio frequency signal. Such an optical or non-radio frequency signal can enable the TAG unit to be used universally without the need for consideration of radio spectrum availability and licensing issues, as may be dictated by different jurisdictions. The emission of an optical signal will also obviate the need to provide an antenna in the TAG unit 12. The optical signal can be reflected within the enclosure of the electrical system being monitored with mirrors capable of being added to further reflect the signals towards an optical receiver present in the repeater unit 20. The optical signal can be used to flood the electrical system enclosure with the signal to ensure that the triggered signal is detected by the repeater unit 20.

It will be appreciated that, irrespective of the type of signal transmitted by the signal transmitter 16, the configuration of the TAG unit 12 of the present invention employs a system whereby the power source 13 remains substantially dormant at all times until the passive temperature operated contact closure 14 is triggered. Such a configuration ensures that the operating life of the TAG unit 12 largely becomes the shelf life of the power source 13.

Referring again to FIG. 1, the repeater unit 20 is located remote from the TAG unit 12, typically within the electrical enclosure being monitored. In one embodiment there may be a single repeater unit 20 provided within the electrical enclosure being monitored, and in other embodiments multiple repeater units 20 may be provided within the electrical enclosure to maximize detection of triggered signals.

The repeater unit 20 receives the signal transmitted by the signal transmitter 16 of the TAG unit 12 through a signal detector or receiver 22 that is compatible with the signal transmitter 16. In this regard, where the signal transmitter 16 of the TAG unit 12 is configured to transmit a signal in the form of an electromagnetic radiation signal, the receiver 22 may be in the form of an antenna or the like. In embodiments whereby the signal transmitter 16 is in the form of an optical transmitter, such as an infrared LED or other light transmitter source, the receiver 22 may be a light receiver or infrared receiver.

The repeater unit also contains a controller 24 to receive and process the signal received by the receiver 22. The controller 24 may be in the form of a microprocessor that is configured to control the transmitter 26 to transmit a signal as a widespread alert, warning that a Hot Spot event has been detected by the system 10. The transmitter 26 may transmit the signal to predesignated personnel or devices and the signal may be in the form of an SMS, Wi-Fi or other widespread wireless alert signal. The controller 24 may also be configured to activate a sound or audio alarm and flash a warning light, to further provide indication of the detection of a hot spot event within the electrical system being monitored. In this regard, appropriate personnel can attend the electrical system and provide the appropriate action to address the issue and return the system to a state of desired function.

In one embodiment, the controller 15 of the TAG unit 12 may be configured to encode the signal transmitted by the signal transmitter 16 to prevent any spurious operation of the repeater unit 20 from signals that are not sent from a TAG unit 12. Such an encoded signal will be detected by the controller 24 of the repeater unit 20 as being associated with a TAG unit 12 and processed accordingly. In yet another embodiment the controller 15 of each TAG unit 12 can be pre-programmed with a series of unique ID numbers so that a signal transmitted by a signal transmitter 16 of a TAG unit is uniquely identified as belonging to that TAG unit 20. In such an embodiment, the controller 24 of the receiver unit 20 is able to identify which of the multiple TAG units 12 have triggered the hot spot alarm and can transmit such information to the personnel responsible for addressing the problem to provide a quicker and easier system for maintenance of the electrical system and identifying the location of the problem.

In a preferred form, when a TAG unit 12 has been triggered by a hot spot event, the signal transmitter 16 may be controlled to transmit the alarm signal several random times over a period of several seconds to ensure the signal is received by the repeater unit 20. During or immediately upon completion of this transmission period, the controller 15 of the TAG unit 12 will provide a visible signal on the body 11 of the TAG unit 12, through a visible LED 17 mounted on the body 11 that may be continuously illuminated or periodically flashing to assist the attending technician to identify which particular TAG unit 12 has sent the alarm.

In the embodiment where the transmitter 16 of the TAG unit 12 is an optical transmitter, such as an infrared LED, there may be instances where the infrared signal emitted by the transmitter 16 is not “seen” by the receiver 22 of the repeater unit 20. This may occur when a TAG unit 12 is positioned within a shadow when installed.

To address this, the system 10 may comprise multiple repeater units 20 and may employ distributed repeater units within the switchboard being monitored, especially for large switchboard systems. Such additional repeater units may be stand-alone and separate units or may be “slave units” that are connected to a central repeater unit 20 within the switchboard system. Infrared reflectors may also or alternatively be installed in the system and in some embodiments; infrared reflecting tape may be strategically positioned throughout the switchboard system to reflect the signal. In such an embodiment, as the receiver 22 of the repeater unit 20 is an infrared receiver, a daisy chain or individual chains of such infrared receivers may be configured to emanate from a repeater unit 20 to increase the certainty that at least one of the infrared receivers will receive a signal from each TAG unit 12. By providing software within the controller 24 of the repeater unit 20 that can queue the received TAG unit signals, data collision between multiple receivers receiving the signals simultaneously can be avoided, thereby avoiding system corruption.

As previously discussed, in the system of the present invention, the TAG units 12 only become active upon the detection of a hot spot event. As a result of this, there is no provision for the TAG units 12 to send periodic signals to the repeater unit 20 as an indication of the working status of the TAG units 12, as the power supply 13 is not connected until the passive temperature operated contact closure 14 is triggered.

To provide a means for interrogating the status of a TAG unit 12 and to ensure that it is operational, a magnetic reed switch 30 may be used to enable power to be supplied from the power supply 13 to the controller 15. In such an arrangement, a magnet may be momentarily positioned adjacent a TAG unit 12 to close the reed switch 30 so that the power supply 13 can supply power via an electronic switch to the controller 15 to enable the TAG unit 12 to transmit a signal from the signal transmitter 16 to test the integrity of the TAG unit 12. Alternatively, the reed switch 30 may be connected with one terminal to the power supply side of the passive temperature operated contact closure 14 and the other terminal of the reed switch connected to a separate input pin of the controller 15. This can enable differentiation of a signal generated from the closure of the reed switch contacts and those of the passive temperature operated contact closure 14.

In the arrangement whereby a magnet is employed to test the TAG unit 12, the magnet may be located in a nonconductive rod (not shown), which may be in the form of a probe member. The probe member may also be configured to act as a receiver for the resultant test signal emitted by the transmitter 16, such as an infrared LED of the TAG unit 12 and may include a digital display for conveying the test results to a technician. In this regard, the digital display may provide confirmation the encoded number transmitted by the TAG unit 12 as part of the testing process. During such tests, the Repeater unit 20 may be switched to a mode so as not to repeat any signal that could be remotely interpreted as a hot spot alarm.

The above referenced TAG unit test is able to provide confirmation that each TAG unit 12 is in an operational state. However, in the embodiment where the TAG unit 12 transmits an infrared signal, there is also a need to provide assurance that all infrared signals transmitted by the TAG units 12 actually reach the repeater unit 20 when the switchboard panels are open (i.e. the technician is working inside the switchboard). In such a situation, there exists an opportunity for optimum reflection within the switchboard and interference from outside radiation may occur that can have adverse effects on the operation of the system.

To address this, a validation test has been developed to ensure that each and every TAG unit 12 is able to be received by the repeater unit 20, or one of its slave units, when a TAG unit 12 is activated by a temperature alert. Such a validation test is typically performed after installation of all TAG units 12 and when the switchboard panels are all closed and the switchboard is in its normal closed state for operation.

To initiate the test, a magnet as described above, is held close to the magnetic reed switch 30 for a period of typically 5 seconds. When the magnet is being held close to the magnetic switch, the microprocessor 15 operates to enable power the TAG unit 12 via a metal-oxide-semiconductor field-effect transistor (MOSFET) switch, not shown in the drawings, said MOSFET being connected to the power supply 13. The microprocessor then goes into a sleep mode to conserve power (typically one micro amp sleep current) for the delay duration of typically one hour. During such validation test period of typically one hour, the TAG unit 12 is connected to the power supply 13 via the MOSFET. At the end of the validation test period, the microprocessor 15 of the TAG unit 12 wakes up and instructs the infrared LED transmitter 16 to send a series of typically 5 validation test signals. This can be readily distinguishable from a genuine hot spot alarm condition whereby the temperature activated switch closure will occur for more than the 5-second interval of the test, thereby instructing the controller 15 to immediately commence sending alarm signals. The purpose of such a one hour delay before the validation test signals are sent from each TAG unit 12 is to allow a technician time to perform the 5-second enabling test for each TAG unit 12, and to allow sufficient time to exit the switchboard system and close and lock all the switchboard panels. In this regard, it will be appreciated that the 1-hour time delay may vary in duration from system to system, to provide a sufficient time for a technician to initiate the tests and exit the system.

After the time delay, each TAG unit 12 will transmit the test signals, typically in the form of five randomly spaced test signals. In one embodiment, the test signals are around one millisecond in duration. After transmission, the test signals are then to be received and validated as received by the repeater unit 20.

After an appropriate elapsed time period, typically a time period sufficient to receive signals from all TAG units 12, all of the TAG units 12 that are installed and activated should have been received and validated as present by the repeater unit 20. In an event where a signal from a TAG unit 12 has not been received by the repeater unit 20, the controller 24 will assume that the TAG unit 12 is either faulty or not able to be “seen” be the repeater, thus requiring either replacement, or corrective action such as the installation and/or reposition of more infrared reflective material.

Following the validation test signals, the microprocessor pin operating the MOSFET is de-energized thus switching off the MOSFET and disconnecting power from the power supply 13 to the microprocessor 15 but for a short time after said power supply 13 is disconnected the microprocessor is powered by the charge on a small value capacitor acting as a short term battery to allow the microprocessor to properly power down and switch off completely thus having the TAG unit 12 consuming no power at all. In this case with the MOSFET off and the microprocessor also off the power supply 13 is again in a substantially dormant state except for some inconsequential leakage current through the switched off MOSFET.

It will be appreciated that upon installing TAG Units 12 in a switchboard the TAG unit number will be entered into the repeater unit 20 so that at any time the quantity and identification number of all TAG units 12 present in the switchboard is known by the repeater unit 20.

In an alternative embodiment, to avoid any false alarms being transmitted by the repeater unit 20 during the testing procedure, the controller 24 present within the repeater unit 20 may be programmed to enter a test mode. In such a test mode, no widespread Hot Spot alarm would be transmitted by the transmitter 26 should the reed switch contact closure momentary cause the TAG unit 12 to activate. Such a momentary contact closure could be readily distinguished by the controller 24 present within the repeater unit 20 from a continuous contact closure as would occur in the case of an over temperature activated closure of the passive temperature operated contact closure 14 or by the above described circuit arrangement where the reed switch leg is connected to a separate input pin of the microprocessor.

In yet another embodiment of the present invention, the controller 15 of the TAG unit 12 may be permanently powered by power supply 13 upon installation. The controller 15 would then be configured to transmit a periodic coded “OK Signal” from the transmitter 16 to be received by the receiver 22 of the repeater unit 20. In such a situation, the controller 24 of the repeater unit 20 may function to transmit a fault signal through the transmitter 26 to a technician, only if the periodic “OK signal” is not received within a given time from each TAG unit 12. Each TAG unit 12 may be programmed to transmit “OK signals” randomly, approximately every month. In one form of the invention, the “OK signals” may to be sent as a series of identical messages specific to each TAG unit 12, with each of the messages taking just a few milliseconds (typically around 5 ms) and being transmitted at approximately 50 ms apart over an approximate one month period. The above time durations and intervals are provided by way of an example of how the system may be configured and other time durations and intervals are also envisaged and will be dependent upon the requirements of the system being installed.

In order to prevent data collision from many TAG units 12 transmitting at similar intervals, the microprocessor 15 in each TAG unit 12 would be programmed to have a pseudo random number generator used to trigger the transmissions.

Similarly, in such an embodiment any incidences of a flat battery in a TAG unit 12 would be alerted to a maintenance technician by the absence of an OK signal transmitted by the repeater unit 20. Alternatively, the microprocessor 15 present on each TAG unit 12 may periodically measure the TAG battery voltage and transmit a signal indicating a low battery charge status to the repeater unit 20 to be transmitted to maintenance teams for correction. In addition, the microprocessor 15 on each TAG unit 12 is configured to provide an option for measuring and signaling the battery condition in any or all transmissions. The microprocessor 15 on each TAG unit 12 also includes the battery voltage/condition data with all transmissions including, but not limited to, all tests when the magnet is used to activate a test on a TAG as well as for the validation tests, and a signal indicating an over temperature. The microprocessor 15 further includes an analogue to digital converter (ADC) to determine the battery voltage.

In the event of a hot spot triggering the TAG unit 12 to emit an alarm, the signal enabled by the controller 15 in the TAG unit would be different from the OK signal being periodically transmitted by the TAG unit. Such an alarm signal would comprise an appropriate signal encoded with the particular TAG unit ID number to indicate the location of the Hot spot.

In the case of the embodiment with the OK monitored TAG it is understood that a manufactured TAG may sit in a manufacturers supply stock for a period of time before being installed into a hot spot monitoring situation. In such a storage mode the battery would not be connected to the microprocessor so not drainage current would be lost. In the case when the OK monitoring type of TAG is installed for the first time it is necessary to turn the microprocessor “on” at installation. This can be achieved by momentary introduction of a magnet to the reed switch in the circuit arrangement where the reed switch is connected to the battery side of the temperature activated contact closure with the other leg of the reed connected to a separate input pin of the microprocessor.

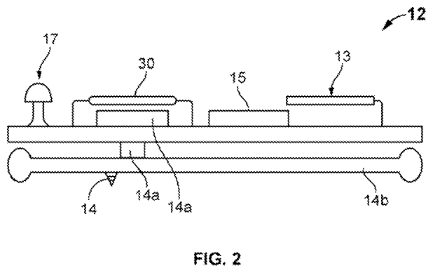

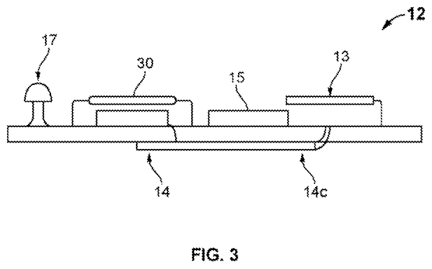

As discussed above, the passive temperature operated contact closure 14 of the TAG unit 12 may take any of a variety of forms, as depicted in FIG. 2 and FIG. 3.

Referring to FIG. 2, the passive temperature operated contact closure 14 of the TAG unit 12 is in the form of a micro-switch 14a that is pressed to be in a biased open position by pressure applied by a glass ampoule 14b. The glass ampoule 14b is a commonly available glass temperature triggered fracture ampoule of the type commonly used in overhead fire sprinkler systems. Such devices function in a manner whereby a rise in the temperature surrounding the ampoule, typically due to a fire, causes expansion of a fluid within the ampoule. This expansion of fluid causes the ampoule to fracture and in doing so, releases water onto the fire. Such ampules are low in cost and small in size, being typically 25 mm in length and 3 mm in diameter. The ampules are made to strict standards and are available in different fracture temperature grades, each grade having a different colored internal fluid. The ampules are also extremely strong in compression along their longitudinal axis, with the strength of the ampules being sufficient to resist the pressure of the water in a tube being held at mains pressure and configured to spout water onto a fire when the ampoule fractures at the pre-determined trigger temperature.

In the arrangement of FIG. 2, the ampoule 14b is positioned adjacent the component of the electrical system being monitored and should the component undergo a rise in heat above a predetermined temperature, the ampoule will fracture, allowing the contacts of the micro switch 14a to close. This results in the power source 13 connecting with the microprocessor 15 to initiate a warning signal to be transmitted by the signal transmitter of the TAG unit 12, as previously discussed.

In FIG. 3, an alternative embodiment of the passive temperature operated contact closure 14 of the TAG unit 12 is depicted. In this arrangement, the passive temperature operated contact closure 14 is in the form of a thermally activated thermostat mechanical switch 14c that is positioned on an undersurface of the TAG unit 12. Upon the switch 14c being exposed to a predetermined rise in temperature the switch will activate thereby closing the circuit between the microprocessor 15 and the power source 13 to activate the alarm.

It will be appreciated that the sensing system 10 of the present invention comprises two units to create the alarm to warn of a hot spot event being present in an electrical system. One unit is mounted to the electrical component to be monitored and senses a change in temperature of the electrical component and becomes activated when the change in temperature of the electrical component is above a predetermined amount. The component mounted unit is typically in a dormant state and only becomes active when exposed to an elevated temperature above the predetermined temperature range at which time it will emit a signal to a remotely located repeater unit. The remotely located repeater unit is capable of processing the signal and emitting a warning message to be transmitted to maintenance personnel and appropriate devices to warn them of the event and the need to take appropriate corrective action. Thus, the system of the present invention can be used over extended periods of time as the system can be placed in a dormant state until activated, thereby ensuring the active life of the component mounted unit is the same as the shelf life of the power source. Such a system offers a simple and effective means of long-term monitoring an electrical system for hot spot events.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A system for monitoring a state of excessive heat in one or more components of an electrical system, comprising:
at least one detection unit, each detection unit mounted with respect to a component of the electrical system to be monitored so as to be in thermal contact with the component to be monitored; and
at least one repeater unit remotely located with respect to each detection unit, the repeater unit being configured to receive a signal from at least one of the detection units representative of a state of excessive heat present at the associated component of the electrical system and to emit a warning signal associated therewith;
wherein the at least one detection unit comprises a passive temperature operated contact closure that is triggered when any heat generated at the component to be monitored exceeds a predetermined temperature, wherein the triggered passive temperature operated contact closure causes a power source of the detection unit to supply power to a transmitter mounted within the detection unit to transmit the signal to the repeater unit.

41. A system according to claim 40, wherein the passive temperature operated contact closure comprises a micro switch in contact with a glass ampoule such that upon exposure of the glass ampoule to the predetermined temperature the glass ampoule fractures and causes the micro switch to close thereby facilitating the supply of power to the transmitter.

42. A system according to claim 40, wherein the passive temperature operated contact closure comprises a thermostat mechanical switch such that upon exposure of the thermostat mechanical switch to the predetermined temperature the thermostat mechanical switch closes thereby facilitating the supply of power to the transmitter.

43. A system according to claim 40, wherein the signal transmitted by the detection unit is the form of an electromagnetic radiation signal.

44. A system according to claim 40, wherein the signal transmitted by the detection unit is in the form of an electromagnetic optical or non-radio frequency signal.

45. A system according to claim 40, wherein the detection unit comprises a body configured to be mounted to a surface of the component to be monitored such that a rise in temperature of the component to be monitored will result in a rise in temperature of the body.

46. A system according to claim 45, wherein the body is formed from a heat conductive material to conduct heat generated in the component to be monitored to the passive temperature operated contact closure.

47. A system according to claim 40, wherein the power source is contained within the detection unit and is maintained in a dormant state until the passive temperature operated contact closure is triggered, which causes the power source to deliver power to the transmitter to transmit the signal to the repeater unit.

48. A system according to claim 47, wherein the detection unit further comprises a controller that is programmed to control the transmitter of the detection unit to control the signal being transmitted to the repeater unit.

49. A system according to claim 48, wherein the controller is configured to encode the signal transmitted by the transmitter.

50. A system according to claim 49, wherein the encoded signal generated by the controller comprises an ID code that is received by the repeater unit and which identifies the detection unit transmitting the encoded signal.

51. A system according to claim 50, wherein the repeater unit, upon receiving the encoded signal emits a warning signal that identifies the detection unit that generated the signal.

52. A system according to claim 50, wherein upon triggering of the passive temperature operated contact closure, the controller controls the transmitter of the detection unit to transmit the signal multiple times over a predetermined period to ensure the signal is received by the repeater unit.

53. A system according to claim 49, wherein the detection unit comprises a light source mounted on a surface thereof and upon triggering of the passive temperature operated contact closure, the controller controls the light source to become illuminated to identify the detection unit.

54. A system according to claim 40, further comprising an interrogation device for interrogating the status of each detection unit when in a passive state.

55. A system according to claim 54, wherein the interrogation device comprises a magnet member that is brought into close proximity to the detection member to close a reed switch connected in parallel with the passive temperature operated contact closure, between the controller and the power supply.

56. A system according to claim 54, wherein the interrogation device comprises a magnet member that is brought into close proximity to the detection member to close a reed switch connected with one terminal to the power supply side of the passive temperature operated contact closure and the other terminal of the reed switch to a separate input pin of the controller.

57. A system according to claim 56, wherein closure of the reed switch by the magnet member of the interrogation device will result in the controller being connected to the power supply to facilitate transmission of a test signal from the transmitter which can be used to test the integrity of the detection unit when in a passive state.

58. A system according to claim 49, wherein the controller is constantly powered by the power supply and is configured to transmit a periodic OK signal from the transmitter to the repeater unit.

59. A system according to claim 58, wherein upon the repeater unit failing to receive an OK signal within a predetermined time period, the repeater unit will transmit a fault signal to a maintenance provider for attention.
